(19) United States
(12) Patent Application Publication
(10) Pub. No.: US 2026/0229232 A1
(43) Pub. Date: Aug. 6, 2026

(54) METHOD AND APPARATUS FOR ENHANCING AN INTERACTIVE VOICE RESPONSE SYSTEM WITH GENERATIVE AI FUNCTIONALITY

(71) Applicant: PRICEWATERHOUSECOOPERS LLP, Toronto (CA)

(72) Inventors: Vik PANT, Toronto (CA); Bahar SATELI, Montreal (CA); Michelle BOURGEOIS, Toronto (CA)

(21) Appl. No.: 19/530,488

(22) Filed: Feb. 5, 2026

(30) Foreign Application Priority Data
Feb. 5, 2025 (CA) 3264263

(51) Int. Cl. G10L 15/22; G06F 16/3329

(52) U.S. Cl. CPC G10L 15/22; G06F 16/33295

(57) ABSTRACT

An Interactive Voice Response (IVR) system, comprising a user interface configured to receive an incoming user inquiry, a response generation module configured to process the inquiry and generate a response, a Generative AI agent interface, wherein the response generation module is configured to direct at least partially the user inquiry through the Generative AI agent interface to a Generative AI agent for processing, and wherein the response generation module is responsive to an output elicited from the Generative AI agent in response to the user inquiry and presented via the Generative AI agent interface to generate the response in response to the output and output the modified response via the user interface.

### CROSS-REFERENCE TO RELATED APPLICATION

The present application claims the priority of Canadian Patent Application No. 3,264,263, filed on Feb. 5, 2025 and incorporated herein by reference.

### FIELD OF THE INVENTION

The invention pertains to the field of Interactive Voice Response (IVR) systems, specifically to methods and systems designed to enhance the functionality of IVR with Transformer-based Generative AI capabilities, thereby delivering an improved user experience. IVR systems are telephony technology that allows automated interaction with callers, utilizing pre-recorded voice statements and menu options via a touch-tone keypad or speech recognition. These systems are traditionally employed for routing calls, providing information, and conducting transactions without human intervention.

This invention provides a method and associated technologies for converting a virtual agent, originally based on IVR technology, to one employing Transformer-based Generative AI to offer services to end-users. Notably, the invention encompasses a process for progressively transitioning from an IVR system to one leveraging Transformer-based Generative AI, thereby ensuring a seamless upgrade in service provision.

The proposed enhancements aim to address limitations in conventional IVR systems, such as inflexible interaction patterns and limited context awareness, by integrating advanced AI techniques. These improvements enable a more dynamic and responsive interaction, allowing the system to better understand and fulfill user requests, ultimately leading to a superior user experience.

### BACKGROUND OF THE INVENTION

Traditional Interactive Voice Response (IVR) systems have been a cornerstone of customer service for many years. These systems utilize pre-recorded prompts and touch-tone or basic voice recognition inputs to navigate callers through a menu. They are cost-effective for managing predictable and repetitive inquiries, such as payment questions or account balances, and can efficiently direct calls to appropriate departments. However, these systems often frustrate customers due to their inflexible menus and limited adaptability, resulting in high rates of call abandonment. Traditional IVR systems are characterized by one or more of the following characteristics:
a. Rule-based logic: Operate on explicitly defined rules, heuristics or decision trees;
b. Deterministic behavior: Produces the same output for the same input, no learning over time;
c. Limited context awareness - Context must be explicitly encoded into the system, limiting its ability to infer nuanced user needs.
d. Human dependent Updates: Any changes or optimization to the system require manual intervention by developers or administrators.

On the other hand, AI voice or text assistants leverage machine learning and natural language processing (NLP) to engage callers in a conversational, human-like way. Customers can ask questions naturally, and the AI interprets their needs and responds accurately. AI voice or text assistants offer natural, conversational interactions, contextual understanding, and scalability, making them more adaptable and efficient for complex inquiries. AI agents are characterized by one or more of the following characteristics:
a. Adaptive Behavior: Learns or improves over time based on data, interactions and feedback.
b. Contextual Understanding: Uses advanced algorithms to understand context, user preferences, and nuanced inputs, such as tone, intent, etc.
c. Autonomous Decision Making: Capable of making decisions in uncertain environments by leveraging probabilistic model and reinforcement learning.
d. Real-Time learning: Adjusts to new patterns or trends dynamically, often without human intervention.
e. Broad Functionality: Integrates across various domains, offering multi-tasking and scalability.

It is generally recognized that artificial intelligence (AI) agents exhibit performance advantages over traditional Interactive Voice Response (IVR) systems. Nevertheless, a substantial installed base of IVR systems remains in widespread use across the industry. Migration from an operational IVR system to an AI-based agent constitutes a technically complex and resource-intensive undertaking. A principal factor impeding adoption is that, notwithstanding known functional limitations, existing IVR systems are well understood, predictable in operation, and capable of delivering a baseline level of service. In contrast, although AI agents are expected to provide improved performance and enhanced user interactions, replacement of an existing system introduces operational uncertainty. This uncertainty is particularly significant for large-scale organizations, for which continuity of client services is critical and for which the risk of widespread service disruption during system transition is unacceptable.

### SUMMARY OF THE INVENTION

The disclosed subject matter relates to an interactive voice response (IVR) system enhanced through integration of a Transformer-based Generative Artificial Intelligence (AI) agent. In an exemplary disclosed configuration, the Transformer-based Generative AI agent is incorporated as a permanent functional component of the IVR system and is configured to augment system capabilities while preserving operational reliability. The Generative AI agent is adapted to provide assistive processing input to the IVR system at selected stages of an operational workflow, thereby enhancing interpretive accuracy and user interaction quality. Legacy IVR logic remains operative to maintain overall control of system execution and governs invocation of the Generative AI agent at predetermined or event-triggered processing junctures.

In a specific and non-limiting example of implementation, the IVR system is operatively connected to one or more users via a communication network and supports bidirectional digital communication. User interaction may occur across one or more communication modalities, including voice, text, video, or combinations thereof. Accordingly, the IVR system supports omnichannel interaction, permitting users to submit inquiries through a single modality or a combination of modalities and to receive corresponding responses through one or more modalities.

The IVR system includes an interface configured to receive user inquiries and transmit responses. The interface is adapted to facilitate communication across supported modalities and to route incoming inquiries to internal functional components of the system for processing. The interface further ensures timely delivery of generated responses to users.

The IVR system further includes a response generation module implemented in software and executable on a computing platform comprising one or more processors, non-transitory memory storage devices, and input/output interfaces. Computer-readable instructions stored in memory, when executed by the processors, cause the system to perform response generation operations.

The processors are configured to handle data volumes and computational operations associated with executing response-generation workflows efficiently and at scale.

A manager module provides central orchestration of response generation. The manager module coordinates processing across multiple functional components, establishes and maintains conversation sessions for individual users, and manages concurrent interactions in an asynchronous manner. Speech-to-text and text-to-speech processing are performed to support voice-based and text-based interaction. The manager module further interfaces with backend services, including enterprise databases and application programming interfaces, to retrieve data necessary for generating accurate responses and may additionally manage authentication and authorization functions.

The manager module coordinates processing by both a legacy logic module and a Transformer-based Generative AI agent. Each processing path receives user inquiries or selected portions thereof and produces a corresponding output. Error handling and fallback mechanisms are provided to address incomplete, ambiguous, or erroneous inputs, including generation of clarification prompts or escalation to a live agent. System interactions and performance metrics are logged for analytics, compliance, monitoring, and system optimization.

The legacy logic module operates independently of artificial intelligence methodologies and employs fixed rules and deterministic processing. Structured database queries are executed to retrieve enterprise data, yielding predictable and fact-based outputs for given inputs. As a result, the legacy logic provides high reliability and accuracy, particularly for data-centric or transactional inquiries.

The Transformer-based Generative AI agent is operatively coupled to a Generative AI service, preferably implemented using a Large Language Model. The Generative AI agent receives prompts derived from user inquiries and generates outputs intended to assist or supplement processing by the legacy logic. In one implementation, the Generative AI agent is invoked when the legacy logic is unable to reliably interpret user intent, such as when mapping a natural-language voice utterance to a predefined menu option. In such cases, the Generative AI agent returns a suggested interpretation that is injected into the legacy workflow to allow continued deterministic processing.

In another exemplary implementation, the legacy logic module and the Transformer-based Generative AI agent operate in parallel, each independently processing the same user inquiry. Outputs from both processing paths are provided to the manager module, which constructs a consolidated response by merging, comparing, selecting, or otherwise reconciling the outputs. Discrepancies between outputs may be identified and logged as part of system performance monitoring.

The hybrid and parallel operating modes enable a controlled and phased integration of Generative AI into the IVR system. While the Generative AI agent provides improved natural language understanding and conversational flexibility, the legacy logic module supplies a deterministic, fact-based reference baseline. This architecture enables progressive validation, fine-tuning, and eventual transition to AI-driven processing without sacrificing system reliability or service continuity.

Performance metrics associated with the Generative AI agent are monitored over time. When error rates exceed predefined thresholds, corrective actions such as model fine-tuning or model substitution may be initiated. Once acceptable performance characteristics are achieved, the legacy logic module may be decommissioned, permitting the Transformer-based Generative AI agent to serve as the primary response-generation mechanism.

This architecture provides a technically advantageous approach for enhancing IVR systems by combining the predictability and data integrity of traditional IVR processing with the contextual understanding and adaptability of Transformer-based Generative AI, thereby improving user experience while maintaining operational robustness.

As embodied and broadly described herein, the invention thus provides a computer-implemented method for operating an interactive voice response (IVR) system, the method comprising:
a. receiving, via a user interface, an incoming user inquiry;
b. processing the incoming user inquiry using legacy logic executing on one or more processors to determine a response-generation workflow;
c. during execution of the response-generation workflow, determining, by an AI integration module, that the incoming user inquiry or at least a portion thereof is to be directed to a Transformer-based Generative AI agent to assist the legacy logic;
d. transmitting, via a Transformer-based Generative AI agent interface, the incoming user inquiry or the portion thereof to the Transformer-based Generative AI agent to elicit an output from the Transformer-based Generative AI agent;
e. receiving, via the Transformer-based Generative AI agent interface, the output elicited from the Transformer-based Generative AI agent; and
f. generating a response to the incoming user inquiry which includes a component based at least in part on the output.

As embodied and broadly described herein, the invention further provides a computer-implemented method for operating an interactive voice response (IVR) system, the method comprising:
a. receiving, via a user interface, an incoming user inquiry;
b. generating, by execution of instructions on one or more processors, a first output by processing the incoming user inquiry in a first processing path using legacy logic;
c. generating, by execution of instructions on the one or more processors, a second output by processing the incoming user inquiry in a second processing path using a Transformer-based Generative AI agent, wherein the first processing path and the second processing path are executed in parallel;
d. providing the first output and the second output to a processing module;
e. constructing, by the processing module, a consolidated response based at least in part on the first output and the second output, including at least one of merging, comparing, selecting, or reconciling content of the first output and the second output; and outputting the consolidated response via the user interface.

### BRIEF DESCRIPTION OF THE DRAWINGS

FIG. 1 illustrates a block diagram of an Interactive Voice Response (IVR) system enhanced with a Transformer-based Generative Artificial Intelligence (AI) agent. The depicted IVR system comprises a plurality of functional modules configured to receive user inquiries, process such inquiries using both legacy logic and Transformer-based Generative AI processing, and output corresponding responses. The Transformer-based Generative AI agent is operatively coupled to the IVR system and is configured to augment system functionality by providing assistive or supplemental processing at selected stages of an inquiry-handling workflow, while the legacy logic maintains overall control of system operation.

FIG. 2 depicts a flowchart illustrating an exemplary process executed by the IVR system of FIG. 1 for handling a user inquiry. The flowchart delineates a sequence of operations in which a response generation module receives an inquiry, interfaces with a Transformer-based Generative AI agent, and selectively directs at least a portion of the inquiry to the Generative AI agent for processing. The flowchart further illustrates how an output generated by the Transformer-based Generative AI agent is received and utilized by the IVR system to produce a response to the inquiry. The response may be generated based on the Generative AI output alone or in combination with output produced by legacy logic, thereby enabling enhanced accuracy, contextual understanding, or user interaction while preserving system reliability.

### DESCRIPTION OF A DETAILED EXAMPLE

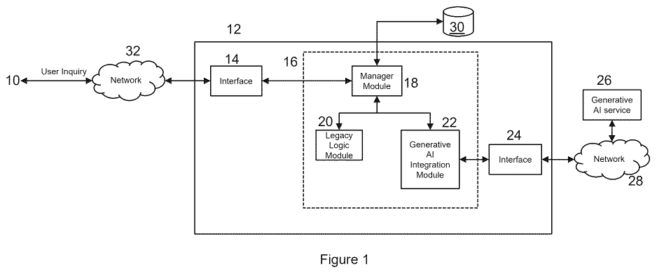

FIG. 1 illustrates a block diagram of an Interactive Voice Response (IVR) system operatively coupled with a Transformer-based Generative Artificial Intelligence (AI) agent. In this configuration, the Transformer-based Generative AI agent is integrated as a permanent component of the IVR system and is configured to augment the operational capabilities thereof. The Transformer-based Generative AI agent is adapted to provide assistive input to the IVR system at designated points within an operational workflow, thereby enhancing system functionality. The IVR system further comprises legacy logic configured to maintain overall control of system operation, while the Transformer-based Generative AI agent contributes to decision-making processes at selected stages of the workflow.

The Interactive Voice Response (IVR) system, designated by reference numeral 12, is operatively connected to one or more users, designated by reference numeral 10 (a single user being shown for ease of illustration), via a communication network 32. The network 32 enables bidirectional communication between the IVR system 12 and the users 10. Such communication is typically implemented in digital form and may employ one or more communication modalities, including, but not limited to, voice, text, and video. Accordingly, the IVR system 12 supports omnichannel communication, permitting a user 10 to submit an inquiry to the IVR system 12 via a single communication modality or a combination of multiple modalities and to receive a corresponding response therefrom.

In one exemplary embodiment involving multi-modal communication, a user 10 initiates an interaction with the IVR system 12 through a cellular telephony channel of the network 32 while concurrently engaging with the IVR system 12 through a web-based interface over an Internet component of the network 32. This configuration enables the user 10 to conduct a voice-based interaction while optionally supplying supplemental information via text input through the web interface.

Consistent with the foregoing, the terms “user inquiry” and “response” are to be interpreted broadly as encompassing communications conveyed through a single medium, such as voice, text, or video, as well as communications conveyed through combinations of multiple media, including voice and text, and equivalent variants thereof.

The IVR system 12 comprises an interface 14 operatively coupled to the network 32. The interface 14 is configured to receive user inquiries from users 10 and to transmit corresponding responses thereto. The interface 14 includes one or more components adapted to facilitate communication between the users 10 and the IVR system 12, and may comprise telecommunication hardware, inquiry-processing software, and connectivity modules enabling interaction across multiple communication modalities, including voice, text, and video. The interface 14 further functions to manage and route incoming inquiries to appropriate functional components of the IVR system 12 and to ensure that responses generated within the system, including responses derived from the Transformer-based Generative AI agent, are delivered to the users in a timely manner.

The interface 14 is operatively connected to a response generation module 16. The response generation module 16 is configured to receive user inquiries, process the inquiries, and generate corresponding responses. The response generation module 16 is software-implemented and executes on a computing platform comprising one or more data processors configured to execute computer-readable instructions. Execution of the computer-readable instructions causes the response generation module 16 to perform functions necessary for generating accurate and contextually appropriate responses.

The computing platform includes, without limitation, one or more central processing units (CPUs), memory storage devices such as random-access memory (RAM) and read-only memory (ROM), and input/output interfaces. The CPUs are configured to process data and execute instructions stored in the memory storage devices. The memory storage devices store computer-readable instructions and operational data in a non-transitory manner. The input/output interfaces facilitate communication between the CPUs and peripheral devices or external systems.

The one or more data processors of the computing platform are configured to handle the data volumes and computational operations associated with executing response-generation algorithms. The data processors operate in conjunction with the memory storage devices to dynamically retrieve, store, and process data, thereby enabling efficient execution of the functions of the response generation module 16.

The response generation module 16 comprises a manager module 18 configured to provide overall operational control and coordination of the response generation module 16. The manager module 18 orchestrates the manner in which the IVR system formulates responses to user inquiries by coordinating processing activities across multiple functional components of the IVR system.

In one non-limiting example, the manager module 18 is configured to perform context management functions, including receiving user inquiries and establishing and maintaining conversation sessions associated with individual users. Multiple conversation sessions may be active concurrently, with each session operating asynchronously such that initiation or termination of one session is independent of the state of other sessions.

The manager module 18 further performs speech and text management functions, including converting spoken user input into text using speech recognition techniques and converting text-based responses into synthesized speech for voice-based output.

The manager module 18 is additionally configured to integrate with backend services to retrieve data required to generate responses. Such backend services may include enterprise databases, such as database 30, customer relationship management (CRM) systems, and application programming interfaces (APIs) that provide access to enterprise data. The manager module 18 may further manage user authentication in connection with such data access.

The manager module 18 also manages processing by both a legacy logic module and a Transformer-based Generative AI agent by triggering response generation operations using each processing path and ensuring that each processing channel receives the requisite input data, including the user inquiry or selected portions thereof, to generate accurate and contextually relevant outputs.

The manager module 18 further provides error handling and fallback functionality by detecting incomplete, ambiguous, or erroneous inputs and determining whether to issue clarification prompts, generate fallback responses, or escalate the interaction to a live agent.

The manager module 18 additionally maintains logs of system interactions for monitoring, analytics, compliance, and performance optimization, including monitoring system performance over time.

As described herein, the manager module 18 controls the response generation process performed by both a legacy logic module 20 and a Transformer-based Generative AI agent.

The legacy logic module 20 is configured to generate responses to user inquiries using traditional IVR techniques. In particular, the legacy logic module 20 operates independently of artificial intelligence methodologies and instead employs fixed rules and deterministic processing. The legacy logic module 20 retrieves enterprise data using structured database queries executed against database 30 or associated data sources, in contrast to vector-based retrieval techniques employed by the Transformer-based Generative AI agent. As a result, for a given input, the legacy logic module 20 produces generally repeatable and predictable outputs.

In a typical operational flow, the legacy logic module 20 receives a user inquiry, which may be converted from voice to text by the manager module 18 when the inquiry is received via a voice channel. The manager module 18 may further process DTMF keypad inputs or other input modalities. The legacy logic module 20 then performs a matching operation against predefined IVR menu options organized in a decision tree. When data retrieval is required, the legacy logic module 20 requests that the manager module 18 execute a structured query against database 30 or associated data sources to obtain the required data.

Upon successful data retrieval, the legacy logic module 20 formulates a response, which may include prerecorded messages or dynamically generated text responses depending on the context of the user inquiry. The formulated response is transmitted to the manager module 18, which facilitates delivery of the response to the user. For text-based responses, the manager module 18 may convert the response into synthesized speech for voice-based output.

The Transformer-based Generative AI agent comprises a Generative AI integration module 22 that functions as an operational interface between the IVR system 12 and a remotely located Generative AI service 26, which is typically hosted in a cloud environment and accessed via a data network 28, such as the Internet. The Generative AI integration module 22 interfaces with the manager module 18 to receive user inquiries and to generate prompts for submission to the Generative AI service 26. The Generative AI service 26 is preferably implemented using a Large Language Model (LLM) configured to generate outputs in response to received inputs.

The Generative AI integration module 22 communicates with the Generative AI service 26 via an interface 24 that forms a functional part of the Transformer-based Generative AI agent.

In one implementation, the Transformer-based Generative AI agent is integrated as a permanent component of the IVR system 12 and is configured to provide focused assistance to the legacy logic module 20. In this configuration, the legacy logic module 20 supplies the Generative AI integration module 22 with system state information and associated data at predetermined or event-triggered points within the operational workflow. The Generative AI agent generates an output that is injected into the legacy logic workflow to enhance response accuracy or user experience without displacing the legacy logic.

For example, when a user interacts with the IVR system via voice and the legacy logic module 20 is unable to reliably map a user utterance to a predefined menu option, the legacy logic module 20 transmits the converted voice-to-text input together with an associated decision tree to the Generative AI integration module 22. The integration module 22 constructs a prompt including the list of selectable options, the converted user utterance, and an instruction to match the utterance to one of the options. The prompt is transmitted via interface 24 and network 28 to the Generative AI service 26, which returns an output identifying a selectable option that best corresponds to the user utterance. The identified option is then conveyed to the legacy logic module 20, which continues execution of the workflow based on that input.

In this manner, the Transformer-based Generative AI agent is permanently integrated to provide targeted assistance to the legacy logic module 20, thereby enhancing functionality and performance of the IVR system 12 without requiring wholesale replacement of the legacy logic with a Generative AI-based system.

In one embodiment, the legacy logic module 20 is configured to retain primary control over the response-generation process and to invoke the Transformer-based Generative AI agent at selected stages of the process. Such invocation may occur at predetermined points within the workflow or in response to the occurrence of defined triggering events. By way of non-limiting example, the Transformer-based Generative AI agent may be invoked to improve interpretation of a user's menu selection, particularly in scenarios in which the user interacts with the IVR system via voice input.

In such a scenario, the legacy logic module 20 transmits to the Generative AI integration module 22 voice-to-text data representative of the user's utterance, together with data defining a decision tree corresponding to selectable menu options available to the user. The Generative AI integration module 22 formulates a prompt that includes the text-converted user utterance, the list of selectable options, and an instruction for mapping the utterance to one of the selectable options.

The prompt is transmitted via the interface 24 and the network 28 to the Generative AI service 26. Responsive thereto, the Generative AI service 26 generates an output identifying a selectable option that most closely corresponds to the user utterance. The identified option is returned to the legacy logic module 20, which then continues execution of the operational workflow based on that input.

In another embodiment, the Transformer-based Generative AI agent is coupled with the legacy logic module 20 in a transitional configuration intended to phase out the legacy logic module and replace it with the Generative AI agent. During this transition period, the legacy logic module 20 and the Transformer-based Generative AI agent operate in parallel. The legacy logic module 20 serves as a fallback mechanism to preserve operational continuity in the event of a failure or degradation of the Generative AI agent. Additionally, the legacy logic module 20 provides a reference baseline against which outputs generated by the Generative AI agent may be evaluated and calibrated, thereby facilitating refinement of the Generative AI agent.

While the legacy logic module 20 may present usability limitations from a user-interaction perspective, the responses generated by the legacy logic module 20 are fact-based and deterministic. For example, when a user requests an account balance, the legacy logic module 20 generates a response by executing a structured database query against the database 30, yielding predictable and accurate results. In contrast, responses generated by the Generative AI agent are probabilistic in nature and may not be strictly grounded in factual data. Large Language Models (LLMs) employed by the Generative AI agent represent statistical knowledge models rather than authoritative data repositories. Consequently, outputs produced by the Generative AI agent may not always be fully consistent with input data, particularly in cases of conflict between supplied data and model-internal representations.

Accordingly, an immediate replacement of the legacy logic module 20 with the Generative AI agent may result in undesirable performance variability. The disclosed ability to progressively integrate the Generative AI agent and to evaluate its outputs against the fact-based responses of the legacy logic module 20 provides a technical advantage. This phased integration enables controlled deployment of the Generative AI agent while maintaining a baseline level of system accuracy and reliability.

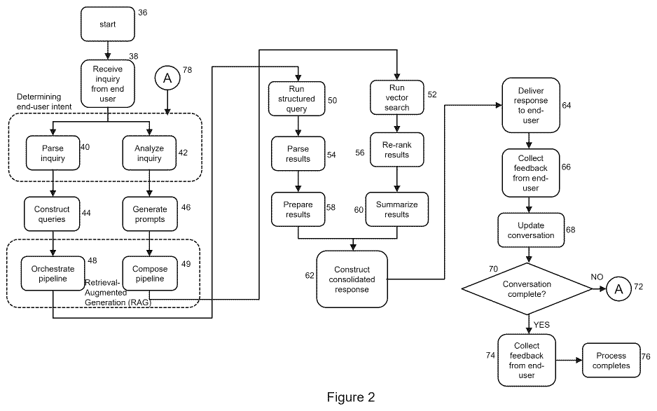

An exemplary implementation of the foregoing embodiment is illustrated by the flowchart of FIG. 2. At step 36, the IVR system 12 is initialized under control of the manager module 18. At step 38, a user inquiry is received via the interface 14 and provided to the manager module 18 for preliminary processing, which may include conversion of a voice input to a text representation using speech recognition technology. The manager module 18 then transmits the processed inquiry to two parallel processing paths: a first processing path executed by the legacy logic module 20 and a second processing path executed by the Transformer-based Generative AI agent.

In the initial processing phase, each processing path attempts to determine user intent. Within the legacy logic processing path, the text-converted inquiry is parsed at step 40 using predefined rules to identify keywords indicative of user intent and to map the identified intent to a corresponding option within a menu of possible actions. At step 44, the legacy logic module 20 constructs one or more data retrieval requests associated with the selected option, and at step 48, a processing pipeline is orchestrated to extract relevant data from database 30.

Concurrently, the Generative AI agent processes the user inquiry through a separate processing path. At step 42, the Generative AI agent analyzes the inquiry to identify a workflow that may be performed to generate an appropriate response. Identification of the workflow may include submitting the inquiry to the Transformer-based Generative AI service, which returns a workflow identifier. At step 46, the Generative AI integration module 22 constructs a prompt corresponding to the identified workflow, and at step 49, a pipeline is composed that may include retrieval of data from database 30 or other data sources and incorporation of that data into the prompt through embedding or referencing mechanisms.

At steps 50, 54, and 58, the legacy logic processing path executes structured database queries, parses query results, and prepares a response. In parallel, at step 52, the Generative AI processing path submits prompts to the Generative AI service 26, receives generated outputs, performs re-ranking at step 56, and generates a summarized output at step 60.

Outputs from both processing paths are then provided to the manager module 18, which constructs a consolidated response based on the respective outputs. In one implementation, the manager module 18 merges the outputs while eliminating duplicative content, thereby producing a response that incorporates factual results from the legacy logic enhanced by contextual information from the Generative AI agent. Alternatively, both outputs may be provided to the Generative AI service 26 with instructions to merge, compare, summarize, or otherwise process the outputs. In such instances, discrepancies identified between the outputs may be flagged and logged by the manager module 18 as indicative of a system fault or performance condition.

At step 64, the generated results are communicated to the user by the manager module 18, which may include converting a text-based response into a synthesized speech format for delivery via a voice channel. At step 66, the system collects feedback associated with the delivered response and updates the status of the corresponding conversation at step 68. If, at decision step 70, the conversation is determined to be complete, final feedback, when available, is collected from the user at step 74 and the process terminates at step 76. Conversely, if the conversation is determined to be incomplete and the user submits one or more additional inquiries, the process proceeds to step 78, initiating a subsequent iteration of the response-generation workflow.

As described herein, the manager module 18 maintains a log of system performance metrics. When analysis of the log indicates that an error rate associated with the Transformer-based Generative AI agent exceeds a predetermined threshold, corrective actions may be initiated. Such actions may include fine-tuning the Large Language Model (LLM) to improve response accuracy or substituting the LLM with an alternative model. This evaluation and adjustment process may be repeated until the error rate is reduced to an acceptable level. Upon achieving the desired performance characteristics, the legacy logic module 20 may be decommissioned, thereby enabling the Transformer-based Generative AI agent to serve as the primary processing channel for response generation.

The foregoing description presents certain embodiments by way of illustration only and is not intended to limit the scope of the invention. Various modifications and variations will be apparent to persons skilled in the art in view of the teachings herein. The scope of the invention is therefore intended to be defined solely by the appended claims, including all equivalents thereof. All features disclosed in this specification, and all steps of any method or process so disclosed, may be combined in any combination, except combinations where at least some of such features or steps are mutually exclusive. References herein to specific embodiments, implementations, or examples are not intended to be limiting, and the invention is not restricted to the disclosed embodiments but encompasses all variations falling within the scope of the claims.

1. A computer-implemented method for operating an interactive voice response (IVR) system, the method comprising:
a) receiving, via a user interface, an incoming user inquiry;
b) processing the incoming user inquiry using legacy logic executing on one or more processors to determine a response-generation workflow;
c) during execution of the response-generation workflow, determining, by an AI integration module, that the incoming user inquiry or at least a portion thereof is to be directed to a Transformer-based Generative AI agent to assist the legacy logic;
d) transmitting, via a Transformer-based Generative AI agent interface, the incoming user inquiry or the portion thereof to the Transformer-based Generative AI agent to elicit an output from the Transformer-based Generative AI agent;
e) receiving, via the Transformer-based Generative AI agent interface, the output elicited from the Transformer-based Generative AI agent; and
f) generating a response to the incoming user inquiry which includes a component based at least in part on the output.

2. The method of claim 1, wherein generating the response comprises injecting the output into the response-generation workflow to modify or select at least one response action and outputting the response via the user interface.

3. The method of claim 1, wherein the legacy logic comprises a deterministic decision process that produces, for a given input representative of the incoming user inquiry, a repeatable output representative of a selected response action.

4. The method of claim 1, wherein the legacy logic comprises rule-based logic configured to map the incoming user inquiry to a predefined option within an interactive menu structure.

5. The method of claim 1, wherein the AI integration module is configured to invoke the Transformer-based Generative AI agent at at least one of (i) predetermined points in the response-generation workflow and (ii) in response to occurrence of a triggering event during execution of the response-generation workflow.

6. The method of claim 1, wherein determining that the incoming user inquiry or the portion thereof is to be directed to the Transformer-based Generative AI agent includes detecting that the legacy logic failed to map a user utterance to a predefined menu option in an option tree, and wherein the output from the Transformer-based Generative AI agent identifies a menu selection corresponding to the user utterance.

7. The method of claim 1, wherein, while eliciting the output from the Transformer-based Generative AI agent, execution of the legacy logic is temporarily suspended, and wherein generating the response comprises resuming execution of the response-generation workflow using the output as an input.

8. The method of claim 1, wherein the legacy logic is configured to retrieve enterprise data using a structured database query, and wherein the Transformer-based Generative AI agent is configured to generate an assistive output using a vector-based search over embedded data items, and wherein generating the response includes incorporating results of the structured database query in the response.

9. The method of claim 1, wherein generating the response comprises at least one of (i) merging a response produced using the legacy logic and the output elicited from the Transformer-based Generative AI agent and (ii) flagging a discrepancy when a response produced using the legacy logic and the output elicited from the Transformer-based Generative AI agent are inconsistent.

10. The method of claim 1, wherein the user interface is configured for omnichannel interaction including at least voice and text, and wherein processing the incoming user inquiry includes converting speech to text and outputting the response includes converting text to synthesized speech.

11. A non-transitory computer-readable storage medium storing instructions which, when executed by one or more processors of an interactive voice response (IVR) system, cause the one or more processors to perform operations comprising:
a) receiving, via a user interface, an incoming user inquiry;
b) processing the incoming user inquiry using legacy logic executing on the one or more processors to determine a response-generation workflow;
c) during execution of the response-generation workflow, determining, by an AI integration module, that the incoming user inquiry or at least a portion thereof is to be directed to a Transformer-based Generative AI agent to assist the legacy logic;
d) transmitting, via a Transformer-based Generative AI agent interface, the incoming user inquiry or the portion thereof to the Transformer-based Generative AI agent to elicit an output from the Transformer-based Generative AI agent;
e) receiving, via the Transformer-based Generative AI agent interface, the output elicited from the Transformer-based Generative AI agent; and
f) generating a response to the incoming user inquiry which includes a component based at least in part on the output.

12. A computer-implemented method for operating an interactive voice response (IVR) system, the method comprising:
a) receiving, via a user interface, an incoming user inquiry;
b) generating, by execution of instructions on one or more processors, a first output by processing the incoming user inquiry in a first processing path using legacy logic;
c) generating, by execution of instructions on the one or more processors, a second output by processing the incoming user inquiry in a second processing path using a Transformer-based Generative AI agent, wherein the first processing path and the second processing path are executed in parallel;
d) providing the first output and the second output to a processing module;
e) constructing, by the processing module, a consolidated response based at least in part on the first output and the second output, including at least one of merging, comparing, selecting, or reconciling content of the first output and the second output; and outputting the consolidated response via the user interface.

13. The method of claim 12, wherein processing the incoming user inquiry in the first processing path comprises mapping the incoming user inquiry to a predefined option within an interactive menu structure using a deterministic decision process.

14. The method of claim 12, wherein processing the incoming user inquiry in the first processing path comprises generating the first output at least in part by executing a structured database query to retrieve enterprise data responsive to the incoming user inquiry.

15. The method of claim 12, wherein processing the incoming user inquiry in the second processing path comprises generating a prompt that includes at least a portion of the incoming user inquiry and transmitting the prompt to a remote Transformer-based Generative AI service to obtain the second output.

16. The method of claim 12, wherein constructing the consolidated response comprises merging the first output and the second output while reducing duplicative content.

17. The method of claim 12, wherein constructing the consolidated response comprises comparing the first output and the second output and flagging a discrepancy responsive to detecting an inconsistency between the first output and the second output.

18. The method of claim 12, wherein constructing the consolidated response comprises selecting between the first output and the second output based on at least one selection criterion indicative of response accuracy or contextual relevance.

19. The method of claim 12, wherein processing the incoming user inquiry in the second processing path comprises performing a vector-based search over embedded data items to obtain information used to generate the second output.

20. The method of claim 12, further comprising determining that the second output is unavailable within a time threshold, and responsive thereto, constructing the consolidated response based on the first output absent the second output.

21. The method of claim 12, further comprising logging, by a monitoring component, performance data associated with at least the second output, and disabling the first processing path responsive to determining from the logged performance data that an error rate associated with the second processing path satisfies a threshold condition.
